(19) United States
(12) Patent Application Publication
(10) Pub. No.: US 2019/0242721 A1
(43) Pub. Date: Aug. 8, 2019

(54) ROAD OBSTACLE IDENTIFICATION SYSTEM AND ROAD OBSTACLE IDENTIFICATION METHOD

(71) Applicant: Toyota Jidosha Kabushiki Kaisha, Toyota-shi (JP)

(72) Inventor: Hiroki Awano, Nerima-ku Toyko (JP)

(73) Assignee: Toyota Jidosha Kabushiki Kaisha, Toyota-shi (JP)

(21) Appl. No.: 16/267,645

(22) Filed: Feb. 5, 2019

(30) Foreign Application Priority Data
Feb. 7, 2018 (JP) 2018-020062

(51) Int. Cl. G01C 21/36; G01S 19/42; G08G 1/0968; H04R 1/08; G01C 21/16

(52) U.S. Cl. CPC G01C 21/3691; G01S 19/42; G01C 21/165; H04R 1/08; G08G 1/096805

(57) ABSTRACT

A road obstacle identification system includes circuitry configured to: acquire information on a position of a vehicle; acquire information on sounds around the vehicle; acquire a moving state of the vehicle; and identify a position of a road having an obstacle based on the information on the position of the vehicle, the information on the sounds around the vehicle, and the moving state of the vehicle.

### CROSS-REFERENCE TO RELATED APPLICATION

This application claims priority to Japanese Patent Application No. 2018-020062 flied on Feb. 7, 2018, incorporated herein by reference in its entirety.

### BACKGROUND

### 1. Technical Field

The present disclosure relates to a road obstacle identification system and a road obstacle identification method.

### 2. Description of Related Art

Japanese Patent Application Publication No. 2007-3277 (JP 2007-3277 A) discloses a navigation device that acquires road information through a VICS (R) receiver and, if the road information includes information on a construction site, sets a predetermined area around the construction site as an impassable section.

### SUMMARY

Road information acquired from the VICS (R) receiver disclosed in JP 2007-3277. A may not include information showing a road obstacle that has arisen unpredictably. It will be useful if a road having an obstacle can be identified based on information acquired by a vehicle moving on the road having an obstacle.

The present disclosure provides a technique of identifying a road having an obstacle based on information acquired by a moving vehicle.

A first aspect of the disclosure provides a road obstacle identification system, including circuitry configured to: acquire information on a position of a vehicle; acquire information on sounds around the vehicle; acquire a moving state of the vehicle; and identify a position of a road having an obstacle based on the information on the position of the vehicle, the information on the sounds around the vehicle, and the moving state of the vehicle.

According to the first aspect the position of a road having an obstacle can be identified based on information from a vehicle that is moving on the road having an obstacle. Identifying a road having an obstacle based on sound information involves less processing load than analyzing images.

In the first aspect, the circuitry may be configured to identify the road having the obstacle based on the information on the sounds around the vehicle and the information on the position of the vehicle that are acquired at a time when a circumventing motion of the vehicle is identified based on the moving state of the vehicle.

In the first aspect, the circuitry may be configured to guide the vehicle along a route that circumvents the road having the obstacle.

In the first aspect, the moving stale acquisition unit may include a sensor installed in the vehicle and configured to detect the moving state of the vehicle, and the circuitry may be configured to acquire the moving state of the vehicle based on a detection result of the sensor.

A second aspect of the disclosure provides a road obstacle identification method including: acquiring information on a position of a vehicle; acquiring information on sounds around the vehicle; acquiring a moving state of the vehicle; and identifying a position of a road having an obstacle based on the information on the position of the vehicle, the information on the sounds around the vehicle, and the moving state of the vehicle.

According to the second aspect, the position of a road having an obstacle can be identified based on information from a vehicle that is moving on the road having an obstacle. Identifying a road having an obstacle based on sound information involves less processing load than analyzing images.

The aspects of the present disclosure can provide a technique of identifying a road having an obstacle based on information acquired by a moving vehicle.

### BRIEF DESCRIPTION OF THE DRAWINGS

Features, advantages, and technical and industrial significance of exemplary embodiments of the disclosure will be described below with reference to the accompanying drawings, in which like numerals denote like elements, and wherein:

FIG. 1 is a view illustrating a road obstacle identification device of an embodiment;

FIG. 2 is a diagram illustrating the functional configuration of the road obstacle identification device; and

FIG. 3 is a flowchart illustrating a process of identifying a road having an obstacle.

### DETAILED DESCRIPTION

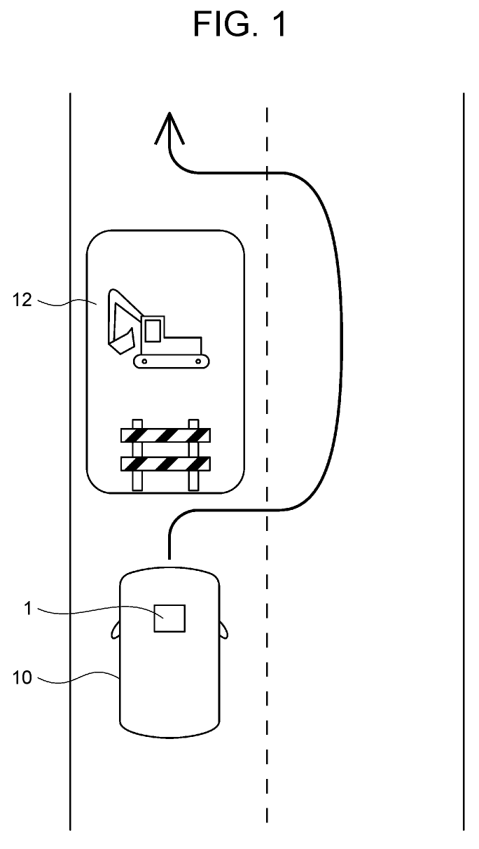

FIG. 1 is a view illustrating a road obstacle identification device 1 of an embodiment. The road obstacle identification device 1 is installed in a vehicle 10 and identifies a road having an obstacle while the vehicle 10 is moving.

When some construction is in progress in a construction zone 12 of a road, construction sounds such as smashing sounds and impact sounds are generated. By detecting the construction sounds, the road obstacle identification device 1 identifies that there is construction. Even when construction sounds are detected, it is unclear whether the road construction is such as to constitute an obstacle to traffic. Therefore, the road obstacle identification device 1 detects whether the vehicle 10 has moved so as to circumvent the construction zone 12 of the road, and identifies a road having a traffic obstacle based on the construction sounds and the circumventing motion of the vehicle 10.

The road obstacle identification device 1 identifies the position of a road having an obstacle, and sends information on the identified position of the road having an obstacle to a server device 26. The server device 26 provides each vehicle with the information on the identified position of the road having an obstacle, thereby allowing users to circumvent the road having an obstacle. In terms of hardware, the server device 26 may be formed by electronic circuitry including a central processing unit (CPU), a memory, and a hard disk.

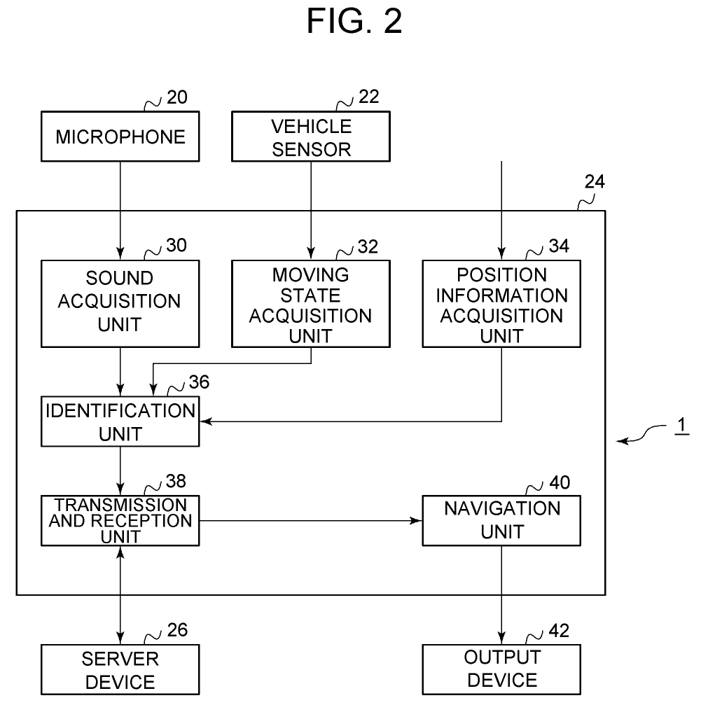

FIG. 2 is a diagram illustrating the functional configuration of the road obstacle identification device 1. In terms of hardware, elements represented as function blocks in FIG 2 that perform various processes can be formed by a circuit block, a memory, and other large-scale integrated (LSI) circuits, and in terms of software, the elements are realized by a program etc. loaded to the memory. Thus, as a person skilled in the art can understand, the function blocks can be realized in various forms, for example, in a hardware-only or software-only configuration or a configuration combining hardware and software, without being limited to any configuration.

The road obstacle identification device 1 includes a microphone 20, vehicle sensors 22, a controller 24, and an output device 42. The controller 24 has a sound acquisition unit 30, a moving slate acquisition unit 32, a position information acquisition unit 34, an identification unit 36, a transmission and reception unit 38, and a navigation unit 40.

The microphone 20 collects sounds outside the vehicle and sends information on the collected sounds around the vehicle to the sound acquisition unit 30. The vehicle sensors 22 detect a moving state of the vehicle. For example, the vehicle sensors 22 include a steering angle sensor that detects a steering angle of a steering wheel, a steered angle sensor that detects a steered angle of a steering mechanism, and a vehicle speed sensor that detects a vehicle speed. The vehicle sensors 22 send detection results to the moving stale acquisition unit 32.

The server device 26 connects to the road obstacle identification device 1 through a network, and transmits and receives information related to a road having an obstacle to and from the road obstacle identification device 1. The server device 26 receives information on the position of a road having an obstacle from the road obstacle identification device 1, as well as provides information on the position of a road having an obstacle identified by another vehicle to the road obstacle identification device 1.

The output device 42 outputs guidance information on a route to a destination and outputs information on a road having an obstacle. The output device 42 is a display and/or a speaker, and provides a driver with information related to route guidance.

The sound acquisition unit 30 of the controller 24 acquires information on sounds around the vehicle from the microphone 20. The moving state acquisition unit 32 acquires information showing a moving state from the vehicle sensors 22, and acquires at least steering angle information used for detecting a circumventing motion of the vehicle. The position information acquisition unit 34 acquires vehicle position information by using the Global Positioning System (GPS). Each of the sound information, the moving slate information, and the position information carries a timestamp indicating the lime of detection, and those pieces of information that have been detected at the same time can he associated with one another by the timestamps.

The identification unit 36 identifies the position of a road having an obstacle based on the vehicle position information, the sound information, and the vehicle moving state. The identification unit 36 detects construction sounds from the sound information, identifies whether the vehicle has moved so as to circumvent a construction zone of the road based on the vehicle moving state information, and identifies the position of the construction zone based on the position information.

The identification unit 36 identifies a road having an obstacle based on the sound information and the position information that are acquired at a time when a circumventing motion of the vehicle is identified based on the vehicle moving slate. In other words, if sounds such as construction sounds are detected from the sound information at the same time as when a circumventing motion of the vehicle is detected from the vehicle moving state information, the identification unit 36 identifies the position of the road having an obstacle.

For example, the identification unit 36 detects construction sounds by pattern matching, and determines that construction sounds have been detected when reference sounds that are stored in advance have been detected from the sound information. The reference sounds include a plurality of patterns of smashing sounds, impact sounds, and other sounds. Identifying an obstacle present on the road based on information on sounds around the vehicle places less processing load on the identification unit 36 than identifying a road having an obstacle by image analysis. The reference sounds are not limited to construction sounds, and may be any sound indicating a cause for a traffic obstacle, for example, the sound of an alarm whistle used for traffic control.

Based on the vehicle moving state information, the identification unit 36 determines that the vehicle has made a circumventing motion when the vehicle has been steered by an angle equal to or larger than a predetermined steering angle at a predetermined vehicle speed or lower. In other words, the identification unit 36 determines that the vehicle has moved so as to circumvent the construction zone when the vehicle has been decelerated and significantly steered.

The identification unit 36 periodically executes the construction sound detection process and the circumventing motion detection process. The identification unit 36 identifies, as a road having an obstacle, a road on which construction sounds and a circumventing motion have been detected at the same time, and sends information on the position of this road lo the transmission and reception unit 38.

The transmission and reception unit 38 transmits the information on the identified position of the road having an obstacle to the server device 26. Thus, the server device 26 can receive, in real time, information on a road having an obstacle from a vehicle that has moved on the road having an obstacle, and therefore can obtain information on the position of a road on which an obstacle has arisen unpredictably. The server device 26 notifies each vehicle of collected pieces of information on the positions of roads having an obstacle, and the transmission and reception unit 38 receives pieces of information on the positions of roads having an obstacle identified by identification units of other vehicles.

The navigation unit 40 creates a route that circumvents the road having an obstacle based on the information on the position of the road having an obstacle received from the server device 26, and guides a driver along this circumventing route. The circumventing route proposed to the driver is output as a voice and/or an image from the output device 42. The information provided by the navigation unit 40 allows the driver to select a route that circumvents a road having an obstacle.

After receiving the information on the position of a road having an obstacle from the in-vehicle transmission and reception unit 38, the server device 26 may give a command to a vehicle passing by the position to transmit an image captured by an in-vehicle camera, and may confirm whether the road has an obstacle by analyzing the transmitted captured image. The server device 26 acquires a captured image of the road having an obstacle from a vehicle running behind the vehicle 10 and analyzes the captured image to identify the cause of the obstacle on the road. This can enhance the reliability of information on a road having an obstacle to be provided to each vehicle, and yet involves less processing load than analyzing captured images transmitted from all the vehicles.

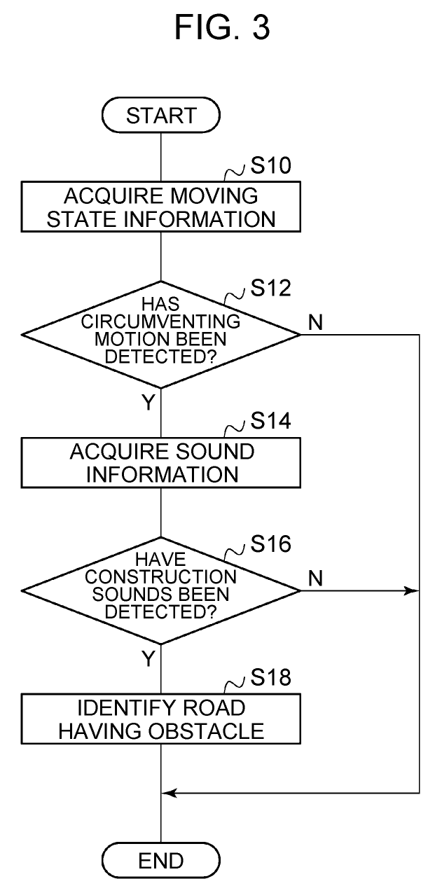

FIG. 3 is a flowchart illustrating the process of identifying a road having an obstacle. The process of identifying a road having an obstacle shown in FIG. 3 is executed periodically. The moving state acquisition unit 32 acquires moving state information (S10). The identification unit 36 detects a circumventing motion of the vehicle based on the moving slate information (S12).

When no circumventing motion of the vehicle has been detected (N in S12), the current process is ended. When the identification unit 36 has detected a circumventing motion of the vehicle (Y in S12), the sound acquisition unit 30 acquires information on sounds around the vehicle detected by the microphone 20 (S14). The identification unit 36 detects whether construction sounds are included in the acquired sound information (S16).

When no construction sounds are included in the sound information (N in S16), the current process is ended. When the identification unit 36 has detected that construction sounds are included in the sound information (Y in S16), the identification unit 36 determines that the road has an obstacle, and identifies, as the position of the road having an obstacle, the position indicated by the vehicle position information acquired al the time of detection of the construction sounds and the circumventing motion (S18). Of the process of detecting a circumventing motion and the process of detecting construction sounds by analyzing sound information, the process of detecting a circumventing motion involves less load. Therefore, the load of the process of identifying a road having an obstacle can be reduced by not executing the process of detecting construction sounds unless a circumventing motion is detected.

The above embodiment is merely an example. As a person skilled in the art can understand, various modified examples of the combination of the components are conceivable and such modified examples are also included in the scope of the present disclosure.

While the aspect in which the process of identifying a road having an obstacle is executed by the in-vehicle controller 24 has been shown in the embodiment, the present disclosure is not limited to this aspect. For example, the server device 26 may have the configuration of the identification unit 36 and execute the process of identifying a road having an obstacle. In this modified example, the controller 24 transmits the sound information, the moving state information, and the position information to the server device 26, and the identification unit of the server device 26 having received these pieces of information identifies the position of the road having an obstacle by detecting construction sounds and detecting a circumventing motion of the vehicle. Thus, the in-vehicle controller 24 and the server device 26 may cooperate with each other to constitute a road obstacle identification system.

What is claimed is:

1. A road obstacle identification system, comprising circuitry configured to:
acquire information on a position of a vehicle;
acquire information on sounds around the vehicle;
acquire a moving state of the vehicle; and
identify a position of a road having an obstacle based on the information on the position of the vehicle, the information on the sounds around the vehicle, and the moving state of the vehicle.

2. The road obstacle identification system according to claim 1, wherein
the circuitry is configured to identify the road having the obstacle based on the information on the sounds around the vehicle and the information on the position of the vehicle that are acquired at a time when a circumventing motion of the vehicle is identified based on the moving state of the vehicle.

3. The road obstacle identification system according to claim 1, wherein
the circuitry is configured to guide the vehicle along a route that circumvents the road having the obstacle.

4. The road obstacle identification system according to claim 1, further comprising
a sensor installed in the vehicle and configured to detect the moving state of the vehicle, wherein the circuitry is configured to acquire the moving state of the vehicle based on a detection result of the sensor.

5. A road obstacle identification method, comprising:
acquiring information on a position of a vehicle;
acquiring information on sounds around the vehicle;
acquiring a moving state of the vehicle; and
identifying a position of a road having an obstacle based on the information on the position of the vehicle, the information on the sounds around the vehicle, and the moving state of the vehicle.
